(19) United States
(12) Patent Application Publication
(10) Pub. No.: US 2026/0127407 A1
(43) Pub. Date: May 7, 2026

(54) AGENTIC ARTIFICIAL INTELLIGENCE

(71) Applicant: ServiceNow, Inc., Santa Clara, CA (US)

(72) Inventors: Gaurav Goyal, San Jose, CA (US); Binny Bhatnagar, Pleasanton, CA (US); Pradeep Gouribhatla, Hyderabad (IN); Vallapureddy Sravya, Telangana (IN); Suhas Kalya Sridhar, Bengaluru (IN); Alekhya Tethali, Hyderabad (IN); Lav Vijayvargiya, Rajasthan (IN)

(21) Appl. No.: 18/936,269

(22) Filed: Nov. 4, 2024

(51) Int. Cl. G06N 3/004; G06F 40/40

(52) U.S. Cl. CPC G06N 3/004; G06F 40/40

(57) ABSTRACT

A method includes obtaining a request defining a use case. The use case includes a natural language description of a problem. Based on the request, the method includes assigning a plurality of agents to the use case. Each respective agent of the plurality of agents includes a respective trained model. The method includes determining a trigger condition associated with the use case is satisfied. The method also includes, based on determining that the trigger condition is satisfied, executing, by one of the agents of the plurality of agents, a tool associated with the use case.

### TECHNICAL FIELD

This disclosure relates to agentic artificial intelligence.

### BACKGROUND

In recent years, the use of chatbots and artificial intelligence (AI) agents has become increasingly prevalent across various industries. These technologies are primarily employed to automate customer service interactions, streamline business processes, and enhance user engagement. Conventional chatbots are typically designed to handle specific tasks such as answering frequently asked questions, providing product information, or assisting with basic troubleshooting. They operate based on predefined scripts and decision trees, which limit their ability to handle complex or dynamic queries effectively.

AI agents, on the other hand, leverage machine learning and natural language processing to offer more sophisticated interactions. These agents can understand and respond to user inputs in a more human-like manner, making them suitable for a broader range of applications. However, traditional AI agents often function as monolithic entities, which can lead to inefficiencies and inaccuracies in problem-solving.

### SUMMARY

One embodiment of the disclosure provides a computer-implemented method for providing an artificial intelligence (AI) agent framework. The method includes obtaining a request defining a use case. The use case includes a natural language description of a problem. Based on the request, the method includes assigning a plurality of agents to the use case. Each respective agent of the plurality of agents includes a respective trained model. The method includes determining a trigger condition associated with the use case is satisfied. The method also includes, based on determining that the trigger condition is satisfied, executing, by one of the agents of the plurality of agents, a tool associated with the use case.

Implementations of the disclosure may include one or more of the following optional features. In some implementations, the plurality of agents comprises an orchestrator agent that assigns one or more tasks to each agent of the plurality of agents based on capabilities of each agent and requirements of each task. Each task may be classified as an autonomous task that is executed without any human intervention or a supervised task that requires human confirmation prior to execution.

In some examples, the plurality of agents includes a communicator agent that communicates with a user or third-party agent. The plurality of agents may include one or more worker agents, and each worker agent of the one or more worker agents may be configured to perform one or more tasks associated with the use case. The trigger condition, in some examples, defines at least one of a chat interaction, a database interaction, or an email interaction.

Optionally, the tool includes at least one of a script or a workflow. In some implementations, the method includes logging prompts and responses for each agent of the plurality of agents. The method may further include assigning, to each agent of the plurality of agents, a strategy from a plurality of strategies for task execution. In some examples, the method further includes obtaining a use case testing request and based on obtaining the use case testing request, simulating execution of the tool associated with the use case. In some of these examples, simulating execution of the tool associated with the use case includes generating a simulation graphical user interface (GUI) view configured to cause a user device to display the simulation GUI view. The simulation GUI view includes a flowchart that reflects an execution order of the plurality of agents.

In some implementations, the method includes generating, by an author using a no-code application development environment, at least one agent of the plurality of agents. In some of these implementations, generating the at least one agent includes obtaining, from the author, natural language describing at least one of a role of the at least one agent or instructions for the at least one agent for executing the tool.

Another embodiment of the disclosure provides a system for an AI agent framework. The system includes data processing hardware and memory hardware in communication with the data processing hardware. The memory hardware stores instructions that when executed on the data processing hardware cause the data processing hardware to perform operations. The operations include obtaining a request defining a use case. The use case includes a natural language description of a problem. Based on the request, the method includes assigning a plurality of agents to the use case. Each respective agent of the plurality of agents includes a respective trained model. The method includes determining a trigger condition associated with the use case is satisfied. The method also includes, based on determining that the trigger condition is satisfied, executing, by one of the agents of the plurality of agents, a tool associated with the use case.

This embodiment may include one or more of the following optional features. In some implementations, the plurality of agents comprises an orchestrator agent that assigns one or more tasks to each agent of the plurality of agents based on capabilities of each agent and requirements of each task. Each task may be classified as an autonomous task that is executed without any human intervention or a supervised task that requires human confirmation prior to execution.

In some examples, the plurality of agents includes a communicator agent that communicates with a user or third-party agent. The plurality of agents may include one or more worker agents, and each worker agent of the one or more worker agents may be configured to perform one or more tasks associated with the use case. The trigger condition, in some examples, defines at least one of a chat interaction, a database interaction, or an email interaction.

Optionally, the tool includes at least one of a script or a workflow. In some implementations, the method includes logging prompts and responses for each agent of the plurality of agents. The method may further include assigning, to each agent of the plurality of agents, a strategy from a plurality of strategies for task execution. In some examples, the method further includes obtaining a use case testing request and based on obtaining the use case testing request, simulating execution of the tool associated with the use case. In some of these examples, simulating execution of the tool associated with the use case includes generating a simulation graphical user interface (GUI) view configured to cause a user device to display the simulation GUI view. The simulation GUI view includes a flowchart that reflects an execution order of the plurality of agents.

In some implementations, the method includes generating, by an author using a no-code application development environment, at least one agent of the plurality of agents. In some of these implementations, generating the at least one agent includes obtaining, from the author, natural language describing at least one of a role of the at least one agent or instructions for the at least one agent for executing the tool.

Another embodiment of the disclosure provides a computer-readable medium having instructions that, when executed by data processing hardware, causes the data processing hardware to perform operations. The operations include obtaining a request defining a use case. The use case includes a natural language description of a problem.

Based on the request, the method includes assigning a plurality of agents to the use case. Each respective agent of the plurality of agents includes a respective trained model. The method includes determining a trigger condition associated with the use case is satisfied. The method also includes, based on determining that the trigger condition is satisfied, executing, by one of the agents of the plurality of agents, a tool associated with the use case.

The details of one or more implementations of the disclosure are set forth in the accompanying drawings and the description below. Other embodiments, features, and advantages will be apparent from the description and drawings, and from the claims.

### DESCRIPTION OF DRAWINGS

FIG. 1 is a schematic view of an example system for an artificial intelligence (AI) agent framework.

FIG. 2 is a schematic view of AI agents for the framework of FIG. 1.

FIG. 3 is a schematic view of an orchestrator agent.

FIG. 4 is a schematic view of an executor agent.

FIG. 5 is a schematic view of a communicator agent.

FIG. 6 is a schematic view of a worker agent.

FIGS. 7A and 7B are schematic views of a graphical user interface (GUI) for configuring an AI agent.

FIG. 8 is a schematic view of a GUI for testing AI agents.

FIG. 9 is a flowchart of an example arrangement of operations for a method for agentic artificial intelligence.

FIG. 10 is a schematic view of an example computing device that may be used to implement the systems and methods described herein.

Like reference symbols in the various drawings indicate like elements.

### DETAILED DESCRIPTION

The field of artificial intelligence (AI) has seen significant advancements, particularly in the development and deployment of AI agents. These agents are designed to perform a wide range of tasks, from simple automation to complex problem-solving, often working in collaboration with human users. The current landscape of AI agents is characterized by a variety of frameworks and systems, each aiming to enhance efficiency, accuracy, and user experience. However, despite these advancements, several challenges persist that hinder the optimal performance and deployment of AI agents.

For example, conventional AI agent frameworks often rely on monolithic designs, which can lead to inefficiencies, increased risk of hallucinations, and limited reusability. These frameworks typically lack the flexibility to integrate seamlessly with existing tools and systems, making it challenging to leverage prior investments in automation and workflows. Additionally, the absence of a structured approach to agent collaboration and task execution can result in suboptimal performance and user experience. Another significant issue is the difficulty in managing and debugging AI agents, as well as ensuring their security and reliability. The need for human intervention at various stages of task execution further complicates the process, making it less efficient and more prone to errors. Moreover, existing frameworks often do not provide adequate mechanisms for data and memory management, leading to fragmented and inconsistent information handling. These challenges collectively hinder the effective deployment and management of AI agents, limiting their potential to automate tasks and enhance human-AI collaboration.

The framework disclosed herein addresses these issues through a modular design that emphasizes the creation and orchestration of multiple smaller agents, each with distinct roles and capabilities. This modularity reduces hallucinations and improves the accuracy of task resolution by ensuring that agents are focused on well-defined tasks. The framework may include an orchestrator or manager agent that assigns tasks to the most appropriate agents based on their capabilities and the requirements of the task. This central entity handles the navigation and coordination between multiple agents, enhancing overall efficiency.

The framework may feature a collaboration or communication agent that facilitates communication with human users and other third-party agents, ensuring seamless interactions and improving user experience. Worker agents are designed to perform specific tasks, and their modular nature allows for high reusability across different use cases. The framework supports various strategies for agent execution, including ReAct, Plan and Resolve, and LLM Compiler, each chosen based on the specific requirements of the use case. These strategies enable iterative problem-solving, comprehensive planning, and parallel task execution, significantly enhancing the framework's flexibility and efficiency.

Integration with existing tools is made seamless through a no-code/low-code interface, allowing users to define roles, instructions, and strategies for each agent and tool. The framework supports both autonomous and supervised actions, providing the flexibility to execute tasks with or without human intervention. A dedicated playground for testing and debugging agents and use cases further enhances the framework's robustness, allowing for detailed understanding and adjustment of the execution flow.

The framework also includes data and memory management capabilities, utilizing both short-term and long-term memory to store and retrieve information. Optionally, the framework integrates with a knowledge graph to further enrich context information, improving the accuracy and relevance of the agents'actions. Detailed logging and debugging features ensure that all agent activities are meticulously recorded, aiding in troubleshooting and performance optimization.

Human-in-the-loop features allow for configurable levels of human intervention, ranging from copilot or supervised mode, which requires human input at every step, to autopilot mode, which operates autonomously. This flexibility ensures that the framework can adapt to various operational requirements and user preferences. The inclusion of trust builder integration for moderation checks and prompt injection prevention ensures the security and reliability of the AI agents.

Overall, the framework offers a robust, flexible, and efficient solution for automating tasks and enhancing collaboration between AI agents and human users. Its modular design, comprehensive execution strategies, seamless tool integration, no-code/low-code environment, and advanced data management capabilities collectively address the limitations of existing frameworks, providing significant technical improvements and user benefits.

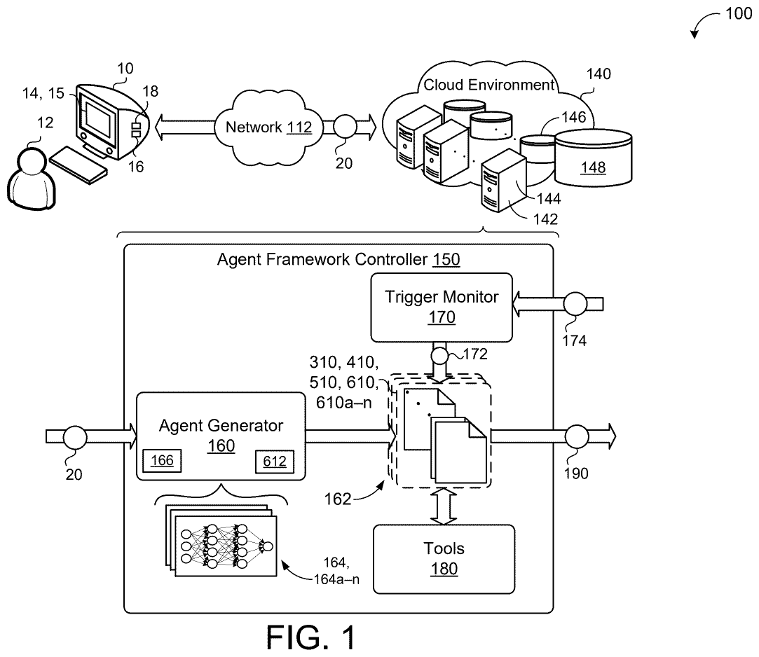

Referring to FIG. 1, in some implementations, a AI agent system 100 includes a remote system 140 in communication with one or more user devices 10 each associated with a respective user 12 via a network 112, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 148 (i.e., a remote storage device) may be overlain on the storage resources 146 to allow scalable use of the storage resources 146 by one or more of the clients (e.g., the user device 10) or the computing resources 144.

The remote system 140 is configured to communicate with the user device 10 via, for example, the network 112. The user device(s) 10 may correspond to any computing device, such as a desktop workstation, a laptop workstation, or a mobile device (i.e., a smart phone). Each user device 10 includes computing resources 18 (e.g., data processing hardware) and/or storage resources 16 (e.g., memory hardware). The data processing hardware 18 executes a graphical user interface (GUI) 15 for display on a screen 14 in communication with the data processing hardware 18. The GUI 15 may be provided by a web browser, a web application, a native application, or a hybrid application running on the user device 10. The GUI 15 may allow the user to create, edit, manage, or test use cases 162 for various software applications or systems.

The remote system 140 executes an agent framework controller 150 that the user device 10 communicates with via the network 112. The agent framework controller 150 is a software application or module that is configured to generate and use a plurality of agents 310, 410, 510, 610, 610a-n for use case 162 management. The agent framework controller 150 may interact with other software applications or modules that provide the GUI 15 or the use cases 162, such as a web server, a web application, a native application, or a hybrid application. Some or all the agent framework controller 150, in some examples, executes on the user device 10 in lieu of or in addition to the remote system 140.

In some implementations, the agent framework controller 150 obtains a request 20 defining a use case 162. For example, the agent framework controller 150 receives the request 20 from the user device 10. The use case 162 may include a natural language description of a problem. The agent framework controller 150 assigns a plurality of agents 310, 410, 510, 610 to the use case 162. Each respective agent 310, 410, 510, 610 includes or is associated with a respective trained model 164, 164a-n. For example, each agent 310, 410, 510, 610 represents one or more large language models (LLMs) or other neural networks. Some agents 310, 410, 510, 610 may be associated with the same model 164 while other agents 310, 410, 510, 610 may be associated with a different model 164. The agent framework controller 150 determines a trigger condition 172 associated with the use case 162 is satisfied. Based on determining that the trigger condition 172 is satisfied, the agent framework controller 150 executes, using one or more of the agents 310, 410, 510, 610, a tool 180 associated with the use case 162.

The agent framework controller 150 may include an agent generator 160, a trigger monitor 170, and a set of tools 180. The agent generator 160 may be configured to generate the agents 310, 410, 510, 610, a tool 180 for each use case 162 based on the request 20, the data store 148, or other sources. The agent generator 160 may obtain, from the user 12 or an author, natural language describing the role or the instructions for each agent 310, 410, 510, 610 for executing the tool. Optionally, the agent generator 160 uses a no-code and/or low-code application development environment to generate one or more of the agents 310, 410, 510, 610.

The use cases 162 may be design time artifacts (e.g., specified by the use 12) that represent broad task domains that any incoming task 166 is classified into. This classification helps with finding the right agents 310, 410, 510, 610 for fulfilling the given task 166. In some examples, the agent generator 160 generates the use case 162 based on a natural language description of a problem or a goal (e.g., obtained via a request 20). For example, a use case 162 for “knowledge generation” may be associated with the description of “fetching details of a task, incident, or case record to generate knowledge articles.” The agent generator 160 may assign one or more tasks 166 to each agent 310, 410, 510, 610 based on the capabilities of each agent 310, 410, 510, 610 and the requirements of each task 166. The tasks 166 may be derived from the natural language description of the request 20. The agent generator 160 may also assign a strategy 612 from a plurality of strategies 612 for task execution to each agent 310, 410, 510, 610. Each agent 310, 410, 510, 610 may be assigned the same or different strategy 612. The agent generator 160 may store the agents 310, 410, 510, 610, the use case 162, the tasks 166, and/or the strategies 612 in the data store 148.

The trigger monitor 170 may be configured to monitor one or more trigger conditions 172 associated with the use case 162. Each trigger condition 172 defines an action or event that triggers the use case 162 and/or one or more agents 310, 410, 510, 610 assigned to the use case 162. For example, the trigger condition 172 defines at least one of a chat interaction (e.g., between a user 12 and another user 12, between a user 12 and an agent 510, between a user 12 and a third-party agent, etc.), a database interaction, or an email interaction that initiates or activates the use case. Using the previous example of the “knowledge generation” use case 162, a trigger condition 172 for this use case 162 may include the generation of an incident ticket. For instance, generation of an incident ticket causes a table or database to be updated with details of the incident ticket, and this modification to the table or database triggers the satisfaction of the trigger condition 172 for the knowledge generation use case 162. As another example, a user 12 may indicate, via a chat interface, that they need to “reset their password.”

The trigger condition 172 may be set explicitly by the user 12 via business logic. Alternatively or additionally, the trigger condition 172 may be set by the user 12 via natural language. The trigger condition 172 may also be set by the agent framework controller 150 based on a natural language understanding of the use case 162 or tasks 166. For example, the user 12 may indicate via business logic that when a user 12 interacts with a “reset password” button, that a use case 162 for resetting a user's password is to be triggered or initiated. The agent framework controller 150 may extend this trigger condition 172 to a natural language request from a user 12 that includes “I need to reset my password”(received via, for example, an email or chat interface).

The trigger monitor 170 may receive trigger information 174 from the user device 10, the data store 148, or other sources (e.g., other applications, modules, third parties, etc.). The trigger monitor 170, in some examples, determines that the trigger condition 172 is satisfied based on the trigger information 174 and provides the agents 310, 410, 510, 610 with some or all of the trigger information 174 or other information associated with the trigger information. Using the previous example, the trigger information 174 includes information included in the table update (e.g., row number, incident number, a time the incident was received/generated, other data defining the incident, etc.) and/or information related to where the trigger information 174 may be retrieved.

The set of tools 180 may include one or more tools 180 that the agents 310, 410, 510, 610 use to perform specific actions or tasks 166 required to solve or advance the use case 162. The tools 180 may include scripts or workflows that automate or facilitate certain functions or features of the software applications or systems. The tools 180 may be existing automations, scripts, or workflows within the system or generated by the agent framework controller 150 or the user 12. The tools 180 may be configured to operate autonomously or require human supervision. The tools may also have different output transformation strategies, such as plain text, abstract summary, or detailed summary, to ensure the output is in a usable format.

The agents 310, 410, 510, 610, using the tools 180, accomplish the tasks 166 to generate one or more outputs 190. The outputs 190 may take a variety of forms depending on the use case 162. For example, the outputs 190 include modifying a table or database (e.g., adding, removing, or editing a row or column), generating a notification (e.g., a text message, a chat message, an email), generating an incident, generating one or more documents, reports, articles, etc., a reservation (e.g., of a meeting room, computing resources, etc.), or any other applicable data that resolves the use case 162 and/or describes how the use case 162 was resolved (or, in some examples, why the use case 162 could not be resolved).

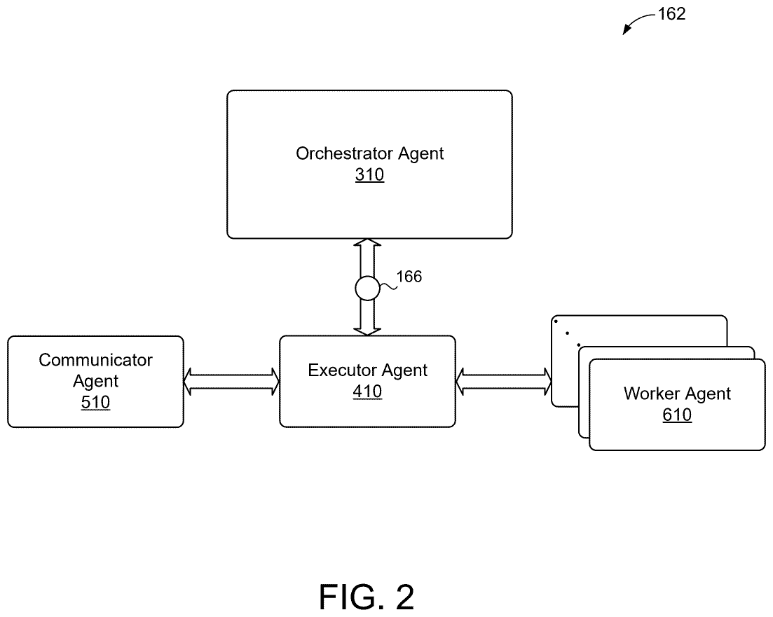

Referring to FIG. 2, in some implementations, each use case 162 is assigned multiple agents 310, 410, 510, 610 that each play a role in solving the problem or achieving the goal associated with the use case 162. The agents 310, 410, 510, 610 may include an orchestrator agent 310, an executor agent 410, a communicator agent 510, and a set of one or more worker agents 610. The orchestrator agent 310 may act as the central entity that assigns tasks 166 to the most appropriate agents 410, 510, 610 based on their capabilities and the requirements of the task 166. The orchestrator agent 310 optionally handles the navigation and coordination between the other agents 410, 510, 610 assigned to the use case 162. The orchestrator agent 310 may communicate with the executor agent 410 to delegate tasks 166 and receive feedback. The orchestrator agent 310, in some examples, performs replanning based on requests from the worker agents 610 or the executor agent 410. The orchestrator agent 310 may include or be associated with a trained model 164 (FIG. 1), such as an LLM or the like, that enables it to reason and plan for the use case 162. The orchestrator agent 310 may automatically be included or assigned to each use case 162.

In some implementations, the executor agent 410 acts as the intermediary between the orchestrator agent 310 and the worker agents 610 or the communicator agent 510. The executor agent 410 may receive tasks 166 from the orchestrator agent 310 and invoke the appropriate worker agents 610 or the communicator agent 510 to execute the tasks 166. The executor agent 410 may also receive outputs from the worker agents 610 or the communicator agent 510 and provide feedback or actions to the orchestrator agent 310. The executor agent 410 may include or be associated with a trained model 164 that enables it to find and invoke agents, collect and provide inputs, and handle agent outputs. The model 164 associated with the executor agent 410 may be the same model 164 as the one associated with the orchestrator agent 310 or different. For example, the model 164 associated with the executor agent 410 is the same as the model 164 associated with the orchestrator agent 310 but is configured differently based on customized prompts for each respective agent 310, 410. The executor agent 410 may automatically be included or assigned to each use case 162.

The communicator agent 510 may facilitate communication with human users or other third-party agents, handling interactions with requesters, admins, or developers. The communicator agent 510 may communicate with the executor agent 410 to receive or provide information, confirmation, or intervention. The communicator agent 510, in some examples, communicates with the users and/or third-party agents using natural language. For example, the communicator agent 510 communicates with a user 12 via a chat interface, email, text messages, phone calls, etc. The communicator agent 510 may include or be associated with a trained model that enables it to analyze user input (e.g., text input, voice input, etc.), display outputs, and manage short-term/long-term memory. The communicator agent 510 may automatically be included or assigned to each use case 162.

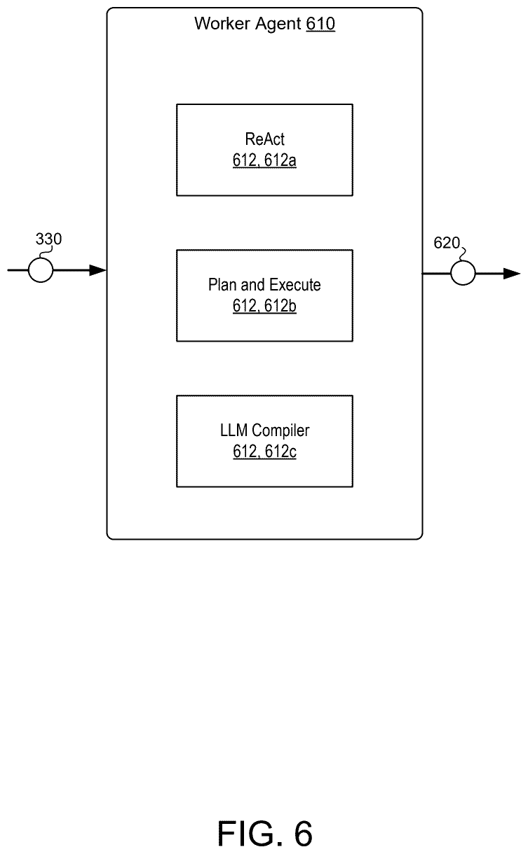

In some implementations, the worker agents 610 are agents created by the user 12 or the agent framework controller 150 to perform specific tasks 166 associated with the use case 162. The worker agents 610 may be numerous and may handle various embodiments of the use case 162. The user 12 and/or the agent framework controller 150 may generate any number of worker agents 610 for different tasks 166 and the user 12 and/or the agent framework controller 150 assign a subset of the generated worker agents 610 to the use case 162 based on the requirements of the use case 162 and the task(s) 166 each worker agent 610 is configured to accomplish. Each worker agent 610 may be reused and assigned to any number of use cases 162 (i.e., the worker agents 610 are modular and reusable). The worker agents 610 may communicate with the executor agent 410 to receive tasks 166, provide outputs, or request more context. The worker agents 610 may include or be associated with one or more trained models that enable them to perform tasks 166 using different strategies 612 (FIG. 6), such as a ReAct strategy 612, 612a, a Plan and Resolve strategy 612, 612b, or a LLM Compiler strategy 612, 612c.

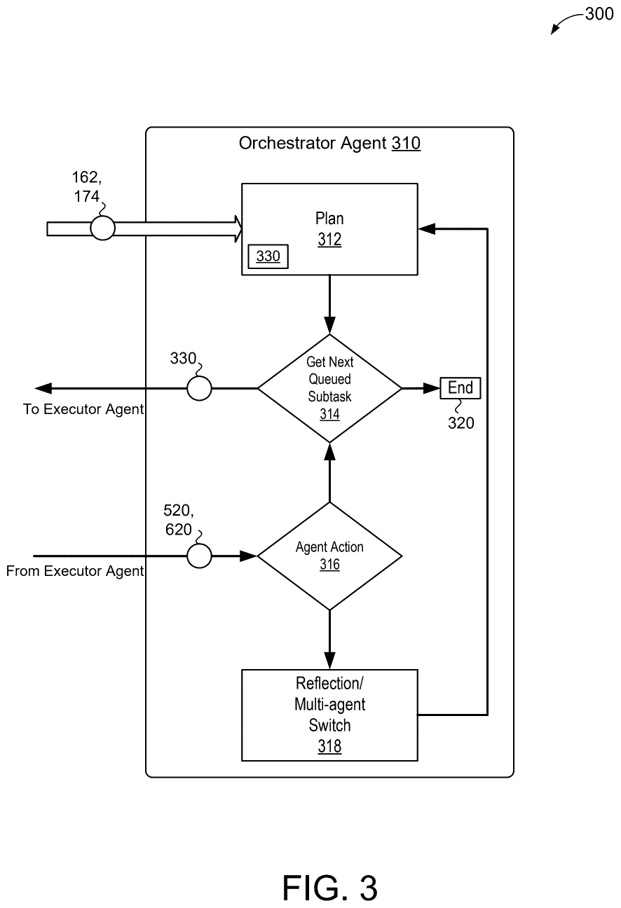

Referring to FIG. 3, in some implementations, the orchestrator agent 310 may follow a flowchart 300 for use case management. The flowchart 300, at operation 312, includes planning for the use case 162 based on the natural language description of the problem or goal, the trigger information 174, other information stored at the data store 148, or other sources. The planning may include generating a set of subtasks 330 with relevant agents 410, 510, 610 assigned to each subtask 330. The subtasks 330, in some examples, are the same as the tasks 166. In other examples, a subtask 330 is a portion of a task 166 (i.e., advances the task 166 or partially accomplishes the task 166). The subtasks 330 may be formatted in a specific JSON structure and may include reasoning for their creation. The planning may follow a hands-off approach, generating high-level subtasks 330 and leaving detailed reasoning to the agents 410, 510, 610 themselves. The flowchart 300, at operation 314, includes getting the next queued subtask 330 from the set of subtasks 330. The flowchart 300, at operation 314, includes determining whether there are more subtasks 330 available. If there are no more subtasks 330 available, the flowchart 300 ends at operation 320. If there are more subtasks 330 available, the flowchart 300, at operation 318, includes delegating the subtask 330 to the executor agent 410.

The flowchart 300, at operation 316, includes receiving an agent output action 520, 620 from the executor agent 410. The agent output action 520, 620 may indicate the completion, the failure, or the need for more context of the subtask 330 by a communicator agent 510 (i.e., communicator agent action 520) or a worker agent 610 (i.e., worker agent action 620). The flowchart 300, at operation 318, includes determining whether the agent output action 520, 620 requires more context. If the agent output action 520, 620 does not require more context, the flowchart 300 returns to operation 314. If the agent output action 520, 620 requires more context, the flowchart 300, at operation 318, includes performing a reflection or a multi-agent switch based on the agent output action 520, 620. The reflection or the multi-agent switch may involve replanning for the subtask 330 or the task 166 or the use case 162 based on the feedback or the request from the executor agent 410 or the worker agents 610. The reflection, in some examples, includes updating the plan for the use case 162, the subtask 330, and/or the agent output action 520, 620. From operation 318, the flowchart 300 returns to operation 312.

With continued reference to FIG. 3, in some implementations, the orchestrator agent 310 includes an agent planner capability (i.e., at operation 312) that generates the set of subtasks 330 with a relevant agent 410, 510, 610 assigned to each subtask 330 based on the natural language description of the problem or goal, the trigger information 174, other information stored at the data store 148, or other sources. The agent planner capability may follow certain guardrails to ensure the quality and efficiency of the subtask generation and assignment. For example, the agent planner capability may format the subtasks 330 in a specific JSON structure that contains the name, description, assigned agent, and reasoning for each subtask 330. The agent planner capability may also provide reasoning for why each subtask 330 was created and why each agent 410, 510, 610 was assigned to it, based on the capabilities and requirements of the agents 410, 510, 610 and the subtasks 330. Furthermore, the agent planner capability may limit the number and granularity of the subtasks 330 to avoid overloading or micromanaging the agents 410, 510, 610, and instead follow a hands-off approach that allows the agents 410, 510, 610 to handle the details and reasoning of the subtasks 330 themselves.

In some implementations, the orchestrator agent 310 may also include an agent reflection capability (i.e., at operation 318) that performs replanning based on the request from the worker agent 610. The agent reflection capability may receive an agent output action 620 from the executor agent 410 that indicates the need for more context or a different agent for the subtask 330. The agent reflection capability may then generate a new subtask 330 that invokes a multi-agent switch, which allows the orchestrator agent 310 to delegate the subtask 330 to another agent 410, 510, 610 that may be more suitable or proficient for the subtask 330. The agent reflection capability may follow certain guardrails to ensure the quality and efficiency of the replanning and the multi-agent switch. For example, the agent reflection capability may format the new subtask 330 in a specific JSON structure that contains the name, description, assigned agent, and reasoning for the new subtask 330. The agent reflection capability may also provide reasoning for why the new subtask 330 was created and why the new agent 410, 510, 610 was assigned to it, based on the feedback or results from the previous agent 610. Furthermore, the agent reflection capability may avoid delegating the new subtask 330 to the same agent 610 that requested the multi-agent switch, to prevent loops or redundancies in the execution flow.

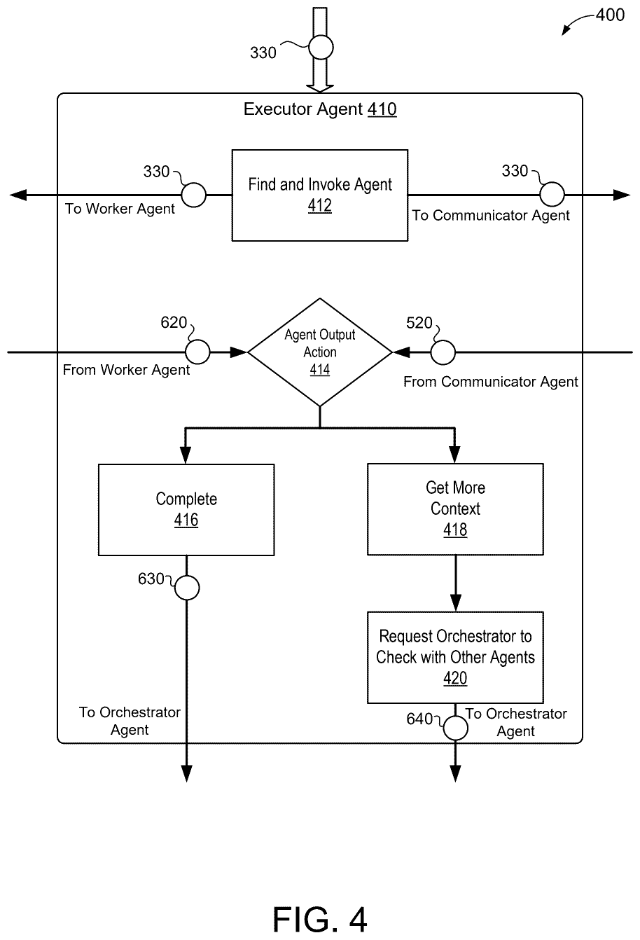

Referring to FIG. 4, in some implementations, the executor agent 410 may follow a flowchart 400 for use case 162 management. The executor agent 410 initially receives a subtask 330 from the orchestrator agent 310. The subtask 330 may include a task description, a task type, a task requirement, and/or a task reasoning. The flowchart 400, at operation 412, includes finding and invoking an agent 510, 610 for the subtask 330 based on the task description, the task type, the task requirement, and/or the task reasoning. The agent 510, 610 may be a worker agent 610 or a communicator agent 510. The flowchart 400, at operation 414, includes receiving an agent output action 520, 620 from a communicator agent 510 or a worker agent 610. The agent output actions 520, 620 may include an output value, an output type, an output format, or an output action. At operation 414, the executor agent 410 determines an agent output action based on the agent output actions 520, 620. The agent output action may include completing, failing, or requesting more context for the subtask 330. When the agent output action indicates that the subtask is complete (via success or failure), the flowchart 400, at operation 416, sends a completion message 630 to the orchestrator agent 310.

When the executor agent 410 determines, based on the agent output action, that more context is required, the flowchart 400, at operation 418, includes generating a request for more context 640, which may include the agent output action. The flowchart 400, at operation 420, sends the request for more context 640 to the orchestrator agent 310. The executor agent 410 then waits for an additional subtask 330 (which may include additional context or clarification per the request for more context 640) from the orchestrator agent 310.

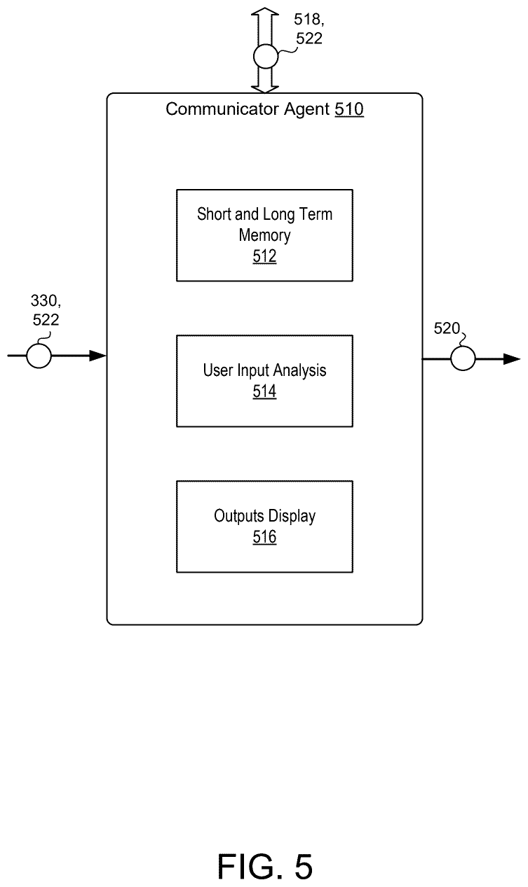

Referring to FIG. 5, in some implementations, the communicator agent 510 may include short-term and/or long-term memory 512, user input analysis 514, and outputs display 516. The memory 512 may store information related to the use case 162, such as the natural language description of the problem or goal, the trigger information 174, the tasks 166, the tools 180, the agents 310, 410, 510, 610, the models 164, the strategies 612, logs, etc. The memory 512 may store information related to the user 12 or z third-party agent, such as a user profile, user preferences, user actions, user feedback, user input, user output, etc. The memory 512 may provide the information to the user input analysis 514 or the outputs display 516 as needed.

The user input analysis 514 may receive user input 518 from the user device 10 or the third-party agent via the network 112. The user input 518 may include text, speech, gesture, sound, or other forms of input that indicate the user's intention, confirmation, or intervention for the use case 162. The user input analysis 514 may analyze the user input 518 using natural language processing, speech recognition, gesture recognition, sentiment analysis, or other techniques to extract the meaning, the function, the feature, or the data of the user input 518. The user input analysis 514 may provide the user input 518 or the analysis result as to the executor agent 410 (i.e., as communicator agent action 520) or the memory 512.

The outputs display 516 may receive subtasks 330 or other outputs 522 from the executor agent 410 or the memory 512. The outputs may include text, speech, gesture, sound, or other forms of output that convey the meaning, the function, the feature, or the data of the use case 162, the tasks 166, the tools 180, the agents 310, 410, 510, 610, the models 164, the strategies 612, the logs, etc. The outputs display 516 may display the outputs 522 on the user device 10 (e.g., the GUI 15) or the third-party agent via the network 112. The outputs display 516 may format, style, or highlight the outputs 522 to attract the user's attention, to emphasize the importance or the likelihood of the outputs 522, or to indicate the compatibility or the suitability of the outputs 522. The communicator agent 510 may include or be associated with a trained model 164 that enables it to communicate with the users 12 and third party agents.

Referring to FIG. 6, in some implementations, each worker agent 610 receives subtasks 330 from the executor agent 410. The worker agent 610, using the strategy 612 assigned to the worker agent 610, performs or accomplishes the subtask 330 to the best of its ability and generates a worker agent action 620 for the executor agent 410. The worker agent action 620 may include information gathered by the worker agent 610, details regarding the results or status of the subtask 330, or any other information related to the use case 162, a task 166, the subtask 330, etc.

The worker agent 610 may be assigned any strategy 612 from a set or group of potential strategies. In some examples, the user 12 selects the strategy 612 when configuring the worker agent 610. In other examples, the agent framework controller 150 selects the optimal strategy 612 based on the tasks 166 and subtasks 330 assigned to the worker agent 610. The potential strategies 612 may include a ReAct strategy 612a (i.e., a Reason+Act strategy 612a), a plan-and-execute strategy 612b, and/or an LLM compiler strategy 612c. The worker agent 610 may receive a subtask 330 from the executor agent 410 and perform the subtask 330 using one of the strategies 612a-c. The worker agent 610 may include or be associated with a trained model 164 that enables it to perform the subtask 330 using the selected strategy 612.

The ReAct strategy 612a may involve reasoning and action steps to solve the task iteratively, improving the chain of thought and ensuring accurate results. The ReAct strategy 612a may use a natural language generation model to generate natural language outputs for the task 166 or subtask 330. The ReAct strategy 612a may alternatively or additionally use a natural language understanding model to understand natural language inputs for the subtask 330.

In some implementations, the ReAct strategy 612a generates a valid next step for a list of given steps (scratchpad) that were taken to reach the current state. The ReAct strategy 612a may use a natural language generation model to generate natural language outputs for the subtask 330, or a natural language understanding model to understand natural language inputs for the subtask 330. The ReAct strategy 612a may follow certain guardrails to ensure the quality and efficiency of the next step generation. For example, the ReAct strategy 612a may limit the number of items generated for the scratchpad to avoid overloading or confusing the worker agent 610. The ReAct strategy 612a may provide reasoning for why each item in the scratchpad was generated and how it contributes to the subtask 330. Furthermore, the ReAct strategy 612a may constrain the subtasks 330 by the available tools 180, and only generate subtasks 330 that can be assigned to some relevant tool 180. The ReAct strategy 612a may also use abstract tools or check with other agents tools to guide the worker agent 610 in a particular way or to invoke a multi-agent switch (FIG. 3), respectively. The ReAct strategy 612a may also use a finish action tool to indicate the completion of the subtask 330 and provide some result for the task 166.

The plan-and-execute strategy 612b may involve generating an entire plan at the beginning and performing replanning after each action step, allowing for reflection and adjustment based on progress. The plan-and-execute strategy 612b may use a planning model to generate a sequence of actions for the subtask 330. The plan-and-execute strategy 612b, in some examples, uses a replanning model to modify the sequence of actions based on feedback or results.

The LLM compiler strategy 612c involves constructing a detailed dependency graph between the subtasks 330 that are involved in solving a given task 166. In this way, this strategy 612c is efficient at completing individual subtasks 330, due to the subtasks 330 being run in parallel. In this case, the term compiler refers to the complication of the main task 1666 into a dependency graph.

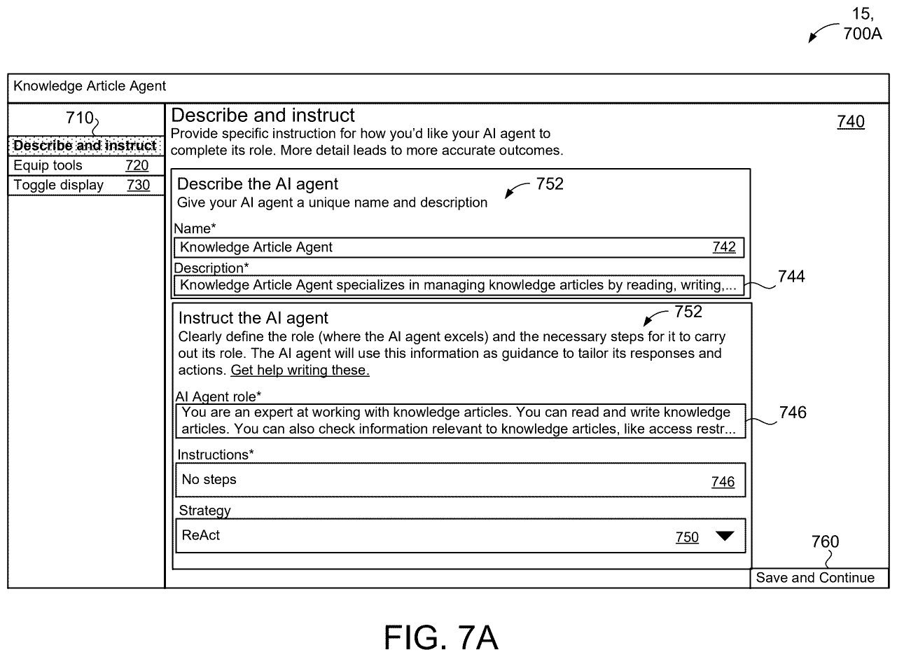

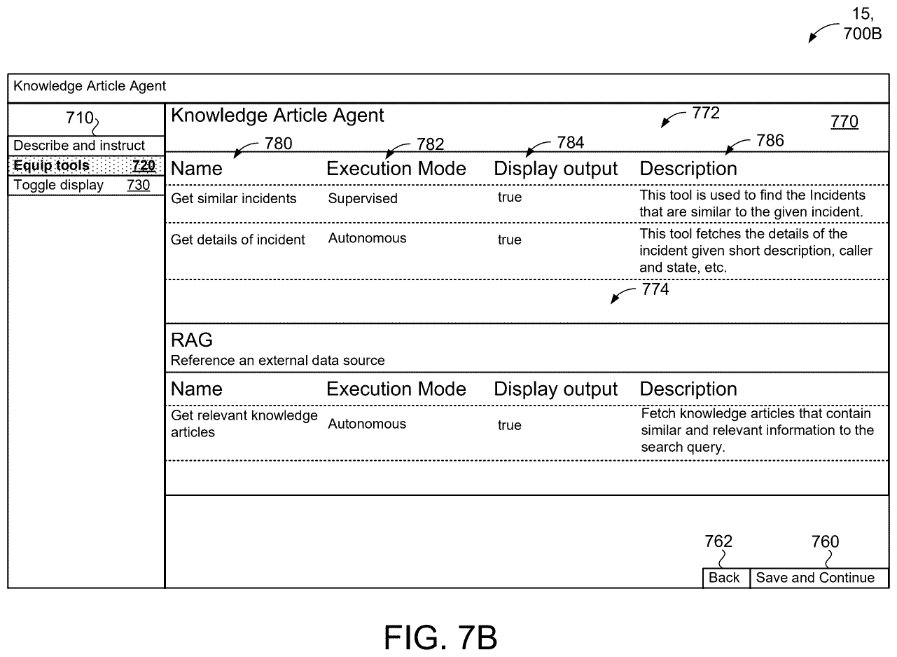

FIG. 7A is a schematic view of an example GUI 15, 700A for creating and configuring a worker agent 610 within the AI agent framework system 100. The GUI 700A may be displayed on the user device 10, such as a desktop workstation, a laptop workstation, or a mobile device, and may allow the user 12, such as a customer, an admin, or a developer, to design and customize any number of worker agents 610 for a specific use case 162 or task 166. The GUI 700A may be provided by a web browser, a web application, a native application, or a hybrid application running on the user device 10. The GUI 700A may include various options, fields, menus, buttons, or other elements that enable the user 12 to provide information and instructions for the worker agent 610 in a no-code or low-code environment, as well as to equip the worker agent 610 with tools 180 and to toggle a display of the worker agent 610.

In some implementations, the GUI 700A may include a “Describe and instruct” option 710, an “Equip tools” option 720, and a “Toggle display” option 730. The user 12 may select one of these options 710, 720, 730 to access different features or functionalities of the GUI 700A. For example, the user may select the “Describe and instruct” option 710 to provide a name, a description, a role, and/or a strategy for the worker agent 610, as well as to define the steps or actions that the worker agent 610 should perform to carry out its role. The user 12 may select the “Equip tools” option 720 to select and configure one or more tools 180 (e.g., scripts, workflows, automations, etc.) that the worker agent 610 can use to perform specific actions required for its role. The user may select the “Toggle display” option 730 to switch between different views or modes of the worker agent 610, such as a text view, a graphical view, or a code view.

In the example of FIG. 7A, the user 12 has selected the “Describe and instruct” option 710, which displays a page 740 that includes several text fields 742, 744, 746, 748, and a drop-down menu 750. The page 740 may also include instructions 752 that guide the user 12 on how to provide the information and instructions for the worker agent 610. For example, the instructions 752 may state “Provide specific instruction for how you'd like your AI agent to complete its role. More detail leads to more accurate outcomes.” The instructions 752 may state “Describe the AI agent” and “Give your AI agent a unique name and description.” In this example, the instructions 752 also include “Instruct the AI agent” and “Clearly define the role (where the AI agent excels) and the necessary steps for it to carry out its role. The AI agent will use this information as guidance to tailor its responses and actions. Get help writing these.” The instructions 752 may include “Strategy” and “Choose a strategy for how the AI agent will execute its role. Learn more about strategies.” The user 12 may enter the name and description of the worker agent 610 in the text fields 742 and 744, respectively.

For example, in FIG. 7A, the user has entered “Knowledge Article Agent” as the name and “Knowledge Article Agent specializes in managing knowledge articles by reading, writing, . . . ” as the description. The user 12 may enter the role and the steps of the worker agent 610 in the text fields 746 and 748, respectively. For example, in FIG. 7A, the user has entered “You are an expert at working with knowledge articles. You can read and write knowledge articles. You can also check information relevant to knowledge articles, like access restr . . . ” as the role and “No steps.” as the steps. The user 12 may select a strategy 612 for the worker agent 610 from the drop-down menu 750. For example, in FIG. 7A, the user has selected “ReAct” as the strategy 612. The drop-down menu may include any number of potential strategies 612 (FIG. 6).

The user 12 may then click on “Save” or “Next” button 760 to save progress and, for example, proceed to the “Equip tools” option 720. Other options not shown here may also be included. For example, the user 12 may click on a “Back” button or the like to return to a previous page or option. Thus, the GUI 700A allows the user 12 to create and configure multiple worker agents 610 for different use cases 162 or tasks 166, and to save, edit, delete, or test the worker agents 610 as desired. The GUI 700A may allow the user 12 to view and manage the worker agents 610 in a dashboard or a list, and to assign the worker agents 610 to different agentic teams or roles. The GUI 700A may communicate with the AI agent framework controller 150 to generate and execute the worker agents 610 according to the information and instructions provided by the user 12.

In some examples, the natural language descriptions and instructions provided by the user 12 are incorporated into a prompt or other input to one or more of the models 164. For example, one of the models 164 is a LLM and when preparing a worker agent 610 to execute one or more tasks 166 or subtasks 330, the agent framework controller 150 generates a prompt for the LLM based on the input provided by the user 12. The prompt may include a prompt template populated at least in part by the natural language provided by the user 12. The agent framework controller 150 may select from several prompt templates based on factors such as the use case 162, the natural language description provided by the user 12, the specific model 164, etc. In some examples, two different worker agents 610 may be associated with the same model 164 (e.g., LLM), but each worker agent 610 is associated with a different prompt for the model 164.

FIG. 7B illustrates GUI 15, 700B for setting up and configuring the tools 180 assigned to a worker agent 610 within the AI agent framework system 100. The GUI 700B may be displayed on the user device 10, such as a desktop workstation, a laptop workstation, or a mobile device, and may allow the user 12, such as a customer, an admin, or a developer, to select and customize one or more tools 180 for a specific use case 162 or task 166. The GUI 700B may be provided by a web browser, a web application, a native application, or a hybrid application running on the user device 10. The GUI 700B may include various options, fields, menus, buttons, or other elements that enable the user 12 to provide information and instructions for the tools 180 in a no-code or low-code environment, as well as to toggle a display of the tools 180.

The GUI 700B may be accessed by selecting the “Equip tools” option 720 in the GUI 700A of FIG. 7A. The GUI 700B includes a main pane 770 that identifies the AI agent 310, 410, 510, 610 being configured. In this example, it is a “Knowledge Article Agent” that specializes in managing knowledge articles by reading, writing, and checking information relevant to knowledge articles. The main pane 770 includes two subsections 772, 774 for adding and configuring general tools and RAG (retrieval-augmented generation) tools, respectively. RAG tools are tools that use a natural language generation model that is augmented with a retrieval component that can access external sources of information, such as a knowledge base or a database, to enrich the generated output. Each subsection 772, 774 includes a name field 780, an execution mode field 782, a display output field 784, and a description field 786. The name field 780 names the tool 180. The execution mode field 782 allows the user 12 to select autonomous mode or supervised mode. In autonomous mode, the agent 310, 410, 510, 610 will execute the tool 180 without any human intervention. In supervised mode, the agent 310, 410, 510, 610 will prompt a human (e.g., via the communicator agent 510) for confirmation before executing the tool 180. The confirmation may include additional context for the user 12. The display output field 784 indicates whether the AI agent 310, 410, 510, 610 should provide a message (via a chat message, email, etc.) to the user 12 of execution of the tool 180. The description field 786 includes a description of the tool 180 and its uses.

In the example of FIG. 7B, the user 12 has added and configured two general tools and one RAG tool for the Knowledge Article Agent. The first general tool is named “Get similar incidents” and is configured to operate in supervised mode and to display a message to the user 12. The description field 786 indicates that this tool 180 retrieves incidents that are similar to the given incident. The second general tool is named “Get details of incident” and is configured to operate in autonomous mode and to display a message to the user 12. The description field 786 indicates that this tool 180 fetches the details of the incident given a short description or other information.

The RAG tool is named “Get relevant knowledge articles” and is configured to operate in autonomous mode and to display a message to the user 12. The description field 786 recites that this tool 180 fetches knowledge articles that contain similar and relevant information to the search query. Thus, configuring the agents 310, 410, 510, 610 to use such tools 180 allows the agent framework controller 150 to leverage existing tools 180, such as scripts and workflows, easily and without modifications.

The user 12 may then click on “Save” or “Next” button 760 to save the progress and, for example, proceed to the “Toggle display” option 730. The user 12 may click on a “Back” button 762 or the like to return to a previous page or option. Thus, the GUI 700B allows the user 12 to equip and configure multiple tools 180 for different use cases 162 or tasks 166, and to save, edit, delete, or test the tools 180 as desired. The GUI 700B may communicate with the AI agent framework controller 150 to generate and execute the tools 180 according to the information and instructions provided by the user 12.

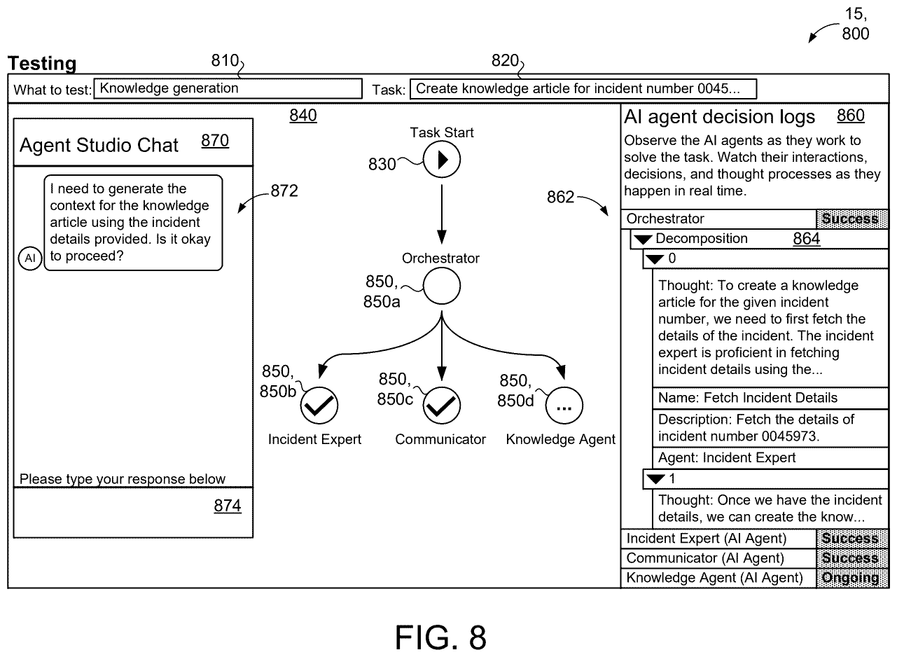

FIG. 8 is a schematic view of an example GUI 15, 800 for testing and monitoring a use case 162 within the AI agent framework system 100. The GUI 800 allows a user 12 to select a use case 162, trigger a task 166, observe the execution flow of the agents 310, 410, 510, 610, and communicate with the agents 310, 410, 510, 610 as needed. The GUI 800 may be displayed on any user device 10 (i.e., as GUI 15), such as a desktop workstation, a laptop workstation, or a mobile device, and may communicate with the AI agent framework controller 150 via the network 112. The GUI 800 may be provided by a web browser, a web application, a native application, or a hybrid application running on the user device 10.

The GUI 800 includes a “what to test” text field 810 for entering which use case 162 to test. The user 12 may enter a natural language description of a problem or goal, such as “knowledge generation”, “password reset”, or “next best action recommendation”. Here, the GUI 800 also includes a “task” text field 820 for setting or triggering the subtask 330 for the use case 162. The user 12 may enter a specific input or event that initiates or activates the use case 162, such as “create knowledge article for incident number 0045 . . . ”, “reset password for user ID 1234 . . . ”, or “recommend next best action for case number 6789 . . . ”. The user may click on a “test” or “start” button 830 to start the testing process.

The GUI 800, in some implementations, includes a flowchart pane 840 that displays an icon 850, 850a-d for each agent 310, 410, 510, 610 working on the task 166. The icons 850 are connected with arrows showing the order that the agents execute in or that data flows. The flowchart pane 840 may also indicate the status of each agent 310, 410, 510, 610, such as whether the agent 310, 410, 510, 610 is waiting, working, or finished. The flowchart pane 840 may provide a high-level overview of the execution flow of the agents 310, 410, 510, 610 and the tasks they perform.

In this example, a first icon 850a represents the orchestrator agent 310, a second icon 850b represents a first worker agent 610 (i.e., an “Incident Expert” worker agent 610), a third icon 850c represents the communicator agent 510, and a fourth icon 850d represents a second worker agent 610 (i.e., a “Knowledge” worker agent 610). Here, the icons 850b, 850c indicate that the respective agents 510, 610 are complete with their task and are awaiting for further instructions via a checkmark. The fourth agent indicates (via a “. . . ”) that the knowledge worker agent 610 is still processing its task.

The GUI 800 also includes an “AI agent decision logs” pane 860 that displays detailed logs of the agents' activities, including their inputs, outputs, decisions, and thought processes. The user 12 may select an agent 310, 410, 510, 610 from a list 862 to view its logs in one or more sub-pane 864. The sub-panes 864 may show the decomposition of the agent's process into subtasks, each with information such as a name, a description, an assigned agent, etc. For example, the user 12 may view the prompts and responses for each agent 310, 410, 510, 610, as well as the tools and strategies they use. The user 12 may use the logs to understand how the agents 310, 410, 510, 610 solve the problem or achieve the goal, as well as to debug or optimize the performance of the agents 310, 410, 510, 610.

In some examples, the GUI 800 includes a chat interface 870 that allows the user 12 to communicate with the agents 310, 410, 510, 610 in natural language. The chat interface 870 may display messages 872 from the agents 310, 410, 510, 610, such as requests for confirmation, information, or intervention, as well as outputs or feedback from the agents 310, 410, 510, 610. The user 12 may enter messages in a text field 874 to provide responses or inputs to the agents 310, 410, 510, 610. The chat interface 870 may facilitate human-in-the-loop interactions with the agents 310, 410, 510, 610, as well as enhance the user experience and trust in the agents 310, 410, 510, 610.

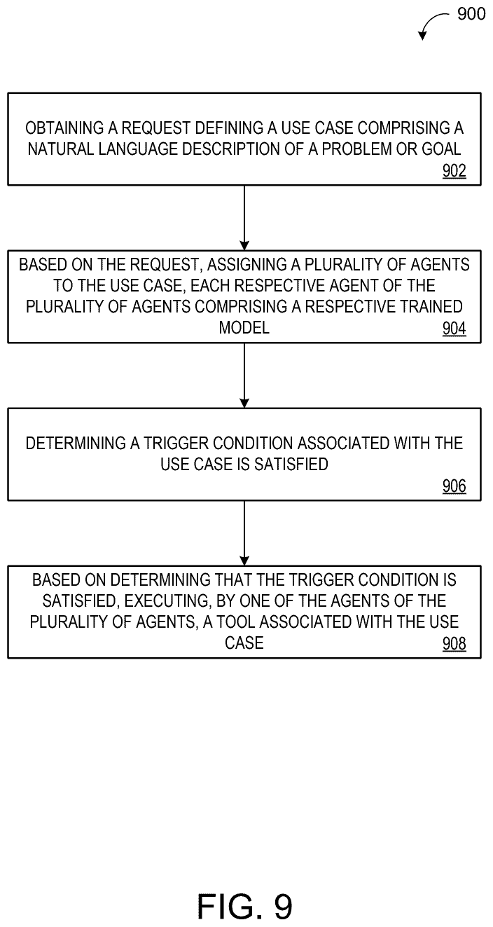

FIG. 9 is a flowchart of an exemplary arrangement of operations for a method 900 for providing an AI agent framework. The computer-implemented method 900, at operation 902, includes obtaining a request 20 defining a use case 162. The use case 162 includes a natural language description of a problem or goal. Based on the request 20, the method 900, at operation 904, includes assigning a plurality of agents 310, 410, 510, 610 to the use case 162. Each respective agent 310, 410, 510, 610 of the plurality of agents 310, 410, 510, 610 includes a respective trained model 164. At operation 906, the method 900 includes determining that a trigger condition 172 associated with the use case 162 is satisfied. At operation 908, the method 900 includes, based on determining that the trigger condition 172 is satisfied, executing, by one of the agents 310, 410, 510, 610 of the plurality of agents 310, 410, 510, 610, a tool 180 associated with the use case 162.

Thus, conventional AI agent frameworks often rely on monolithic designs, which can lead to inefficiencies, increased risk of hallucinations, and limited reusability. These frameworks typically lack the flexibility to integrate seamlessly with existing tools and systems, making it challenging to leverage prior investments in automation and workflows. However, the method 900 addresses these issues through a modular design that emphasizes the creation and orchestration of multiple smaller agents, each with distinct roles and capabilities. This modularity reduces hallucinations and improves the accuracy of task resolution by ensuring that agents are focused on well-defined tasks. The method may include an orchestrator or manager agent that assigns tasks to the most appropriate agents based on their capabilities and the requirements of the task. This central entity handles the navigation and coordination between multiple agents, enhancing overall efficiency.

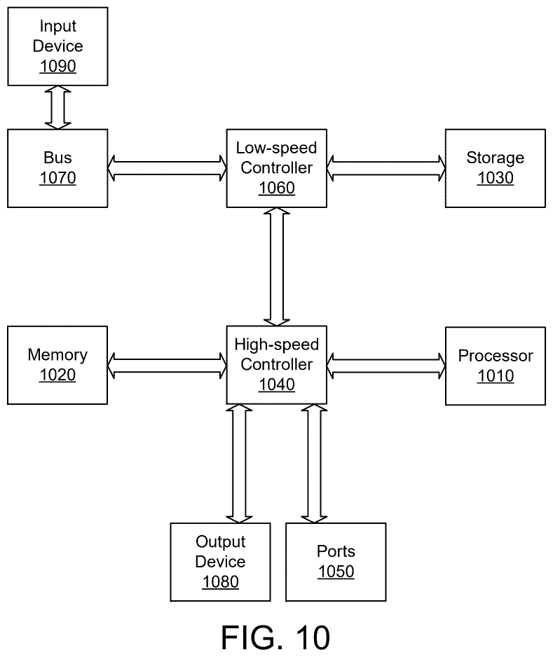

FIG. 10 is a schematic view of an example computing device 1000 that may be used to implement the systems and methods described in this document. The computing device 1000 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 1000 includes a processor 1010, memory 1020, a storage device 1030, a high-speed interface/controller 1040 connecting to the memory 1020 and high-speed expansion ports 1050, and a low-speed interface/controller 1060 connecting to a low-speed bus 1070 and a storage device 1030. Each of the components 1010, 1020, 1030, 1040, 1050, and 1060, are interconnected using various busses, and may be mounted on a common motherboard or in other manners as appropriate. The processor 1010 can execute instructions for performing operations within the computing device 1000, including instructions stored in the memory 1020 or on the storage device 1030 to display graphical information for a graphical user interface (GUI) on an external input/output device, such as display 1080 coupled to high-speed interface 1040. In other implementations, multiple processors and/or multiple buses may be used, as appropriate, along with multiple memories and types of memory. Also, multiple computing devices 1000 may be connected, with each device providing portions of the necessary operations (e.g., as a server cluster, a group of blade servers, or a multi-processor system).

The memory 1020 stores information within the computing device 1000. The memory 1020 may be a non-transitory computer-readable medium, a volatile memory unit(s), or non-volatile memory unit(s). The non-transitory memory 1020 may be physical devices used to store programs (e.g., sequences of instructions) or data (e.g., program state information) on a temporary or permanent basis for use by the computing device 1000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 1030 is capable of providing mass storage for the computing device 1000. In some implementations, the storage device 1030 is a non-transitory computer-readable medium. In various different implementations, the storage device 1030 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 1020, the storage device 1030, or memory on processor 1010.

The high-speed controller 1040 manages bandwidth-intensive operations for the computing device 1000, while the low-speed controller 1060 manages lower bandwidth-intensive operations. Such allocation of duties is exemplary only. In some implementations, the high-speed controller 1040 is coupled to the memory 1020, the display 1080 (e.g., through a graphics processor or accelerator), and to the high-speed expansion ports 1050, which may accept various expansion cards (not shown). In some implementations, the low-speed controller 1060 is coupled to the storage device 1030 and a low-speed expansion port or input device 1090. The low-speed expansion port 1090, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 1000 may be implemented in a number of different forms, as shown in the figure. For example, it may be implemented as a standard server or multiple times in a group of such servers, as a laptop computer, or as part of a rack server system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more embodiments of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining a request defining a use case, the use case comprising a natural language description of a problem or goal;
based on the request, assigning a plurality of agents to the use case, each respective agent of the plurality of agents comprising a respective trained model;
determining a trigger condition associated with the use case is satisfied; and
based on determining that the trigger condition is satisfied, executing, by one of the agents of the plurality of agents, a tool associated with the use case.

2. The method of claim 1, wherein the plurality of agents comprises an orchestrator agent that assigns one or more tasks to each agent of the plurality of agents based on capabilities of each agent and requirements of each task.

3. The method of claim 2, wherein each task is classified as:
an autonomous task that is executed without any human intervention; or
a supervised task that requires human confirmation prior to execution.

4. The method of claim 1, wherein the plurality of agents comprises a communicator agent that communicates with a user or third-party agent.

5. The method of claim 1, wherein the plurality of agents comprises one or more worker agents, each worker agent of the one or more worker agents configured to perform one or more tasks associated with the use case.

6. The method of claim 1, wherein the trigger condition defines at least one of:
a chat interaction;
a database interaction; or
an email interaction.

7. The method of claim 1, wherein the tool comprises at least one of a script or a workflow.

8. The method of claim 1, further comprising logging prompts and responses for each agent of the plurality of agents.

9. The method of claim 1, further comprising assigning, to each agent of the plurality of agents, a strategy from a plurality of strategies for task execution.

10. The method of claim 1, further comprising:
obtaining a use case testing request; and
based on obtaining the use case testing request, simulating execution of the tool associated with the use case.

11. The method of claim 10, wherein simulating execution of the tool associated with the use case comprises generating a simulation graphical user interface (GUI) view configured to cause a user device to display the simulation GUI view, the simulation GUI view comprising a flowchart that reflects an execution order of the plurality of agents.

12. The method of claim 1, further comprising generating, by an author using a no-code application development environment, at least one agent of the plurality of agents.

13. The method of claim 12, wherein generating the at least one agent comprises obtaining, from the author, natural language describing at least one of:
a role of the at least one agent; or
instructions for the at least one agent for executing the tool.

14. A system comprising:
data processing hardware; and
memory hardware in communication with the data processing hardware, the memory hardware storing instructions that when executed on the data processing hardware cause the data processing hardware to perform operations comprising:
obtaining a request defining a use case, the use case comprising a natural language description of a problem or goal;
based on the request, assigning a plurality of agents to the use case, each respective agent of the plurality of agents comprising a respective trained model;
determining a trigger condition associated with the use case is satisfied; and
based on determining that the trigger condition is satisfied, executing, by one of the agents of the plurality of agents, a tool associated with the use case.

15. The method of claim 1, wherein the plurality of agents comprises an orchestrator agent that assigns one or more tasks to each agent of the plurality of agents based on capabilities of each agent and requirements of each task.

16. The method of claim 2, wherein each task is classified as:
an autonomous task that is executed without any human intervention; or
a supervised task that requires human confirmation prior to execution.

17. The method of claim 1, wherein the plurality of agents comprises a communicator agent that communicates with a user or third-party agent.

18. The method of claim 1, wherein the plurality of agents comprises one or more worker agents, each worker agent of the one or more worker agents configured to perform one or more tasks associated with the use case.

19. The method of claim 1, wherein the trigger condition defines at least one of:
a chat interaction;
a database interaction; or
an email interaction.

20. A computer-readable medium having instructions that, when executed by data processing hardware, causes the data processing hardware to perform operations comprising:
obtaining a request defining a use case, the use case comprising a natural language description of a problem or goal;
based on the request, assigning a plurality of agents to the use case, each respective agent of the plurality of agents comprising a respective trained model;
determining a trigger condition associated with the use case is satisfied; and
based on determining that the trigger condition is satisfied, executing, by one of the agents of the plurality of agents, a tool associated with the use case.
